(19) United States
(12) Patent Application Publication
(10) Pub. No.: US 2019/0361116 A1
(43) Pub. Date: Nov. 28, 2019

(54) APPARATUS AND METHOD FOR HIGH-SPEED TRACKING OF VESSEL

(71) Applicant: ELECTRONICS AND TELECOMMUNICATIONS RESEARCH INSTITUTE, Daejeon (KR)

(72) Inventor: Byung-Gil LEE, Daejeon (KR)

(73) Assignee: ELECTRONICS AND TELECOMMUNICATIONS RESEARCH INSTITUTE, Daejeon (KR)

(21) Appl. No.: 16/412,507

(22) Filed: May 15, 2019

(30) Foreign Application Priority Data
May 28, 2018 (KR) 10-2018-0060636

(51) Int. Cl. G01S 13/93; G01S 7/292; G08G 3/02

(52) U.S. Cl. CPC G01S 13/9307; G08G 3/02; G01S 7/2927

(57) ABSTRACT

Disclosed herein are an apparatus and method for high-speed tracking of a vessel. The method for high-speed tracking of a vessel, performed by the apparatus for high-speed tracking of the vessel, includes processing a reflected radar signal that is input, extracting objects from the reflected radar signal that is processed, selecting targets from among the extracted objects, performing advance tracking for the selected targets, and tracking the vessel using the result of advance tracking when an instruction to track the vessel is received.

### CROSS REFERENCE TO RELATED APPLICATION

This application claims the benefit under 35 U.S.C. 119(a) of Korean Patent Application No. 10-2018-0060636, filed May 28, 2018, the entire disclosure of which is incorporated herein by reference for all purposes.

### BACKGROUND OF THE INVENTION

### 1. Technical Field

The present invention relates generally to technology for high-speed tracking of a vessel, and more particularly to technology for enabling high-speed tracking in response to a request to track a vessel by selecting a target and performing advance tracking for the selected target.

### 2. Description of the Related Art

When a vessel is involved in a collision at sea, the collision is regarded as being caused due to the carelessness of the operator of the vessel. However, it is difficult for the operator of a vessel to maintain his or her concentration on sailing and to check and predict all circumstances during sailing.

Accordingly, rather than making the operator of each vessel determine whether a collision will occur and respond thereto, it is more effective to make a control center on land check the movement of all of the vessels, predict a dangerous situation based on the movement, and notify corresponding vessels when there is a high risk of collision in order to prevent sailing vessels from colliding with each other.

Currently, vessel traffic control systems are installed and operated in major ports, and control systems for preventing collisions between sailing vessels are being operated. A Vessel Traffic Service (VTS) personnel performs traffic control by keeping his or her eyes on a screen on which the positions of vessels are displayed, by predicting whether a collision between vessels will occur by checking the distance therebetween based on his or her work experience, and by modifying the sailing paths of vessels that are determined to be highly likely to collide with each other. Also, each vessel identifies neighboring vessels using a radar device or the like installed therein and sails with reference to the identified information.

Meanwhile, with the development of maritime wireless communications, each vessel may transmit vessel information, including the identification information thereof, to a control center using an Automatic Identification System (AIS), whereby the control center may clearly detect the vessel located at a specific position on the sea.

The AIS installed in a vessel transmits Maritime Mobile Service Identity (MMSI) information, through which the vessel can be automatically identified, position information, dynamic information, and the like to the control center, thereby facilitating identification of the vessel and detection of the position thereof and improving control efficiency.

Also, the vessel traffic control system may detect the positions and speeds of vessels by receiving not only AIS information but also data sensed using radar, which is a different kind of sensor. Tracking a target using radar may be performed by analyzing information about many unspecified objects, which is received by a radar transceiver, by extracting the motion characteristics of the corresponding target, and by continuously predicting the movement of the corresponding target.

When a target is tracked using radar, a mathematical filter, such as a Kalman filter, or the like, is used as a tracking filter in order to minimize the number of tracking errors. The tracking filter performs real-time tracking using a dynamic filtering method, in which prediction and updates are repeated. Here, in order to continuously track the target in the tracking process, it is necessary to accurately select a target object from among multiple objects.

Also, when the target object is selected using a single radar image, many errors may occur, and it is difficult to correctly perform control. When a VTS personnel urgently requires information pertaining to the risk of collision, the target object may be tracked through a single radar scan, but many errors may occur in this case. Also, a prediction error in the process of predicting the movement of a vessel causes damping, whereby a direction line indicative of the direction of the movement of the vessel is made unclear.

Also, it takes a lot of time to perform multiple Kalman filtering processes for predicting the position, the direction, the speed, and the like of a vessel. It takes about 15 seconds for the conventional control system to receive a tracking instruction from a VTS personnel, extract a target object, track the same, and deliver information thereabout to the VTS personnel.

Therefore, it is necessary to develop a method for quickly tracking a vessel in an urgent situation and improving the accuracy of vessel tracking.

### DOCUMENTS OF RELATED ART

(Patent Document 1) Korean Patent No. 10-1758576, published on Jul. 17, 2017 and titled “Method and apparatus for detecting object with radar and camera”.

### SUMMARY OF THE INVENTION

An object of the present invention is to select an object that looks like a vessel as the advance tracking target, to perform advance tracking, and to quickly track a vessel using the result of advance tracking.

Another object of the present invention is to quickly recognize the risk of a collision between vessels and to quickly respond thereto.

A further object of the present invention is to preferentially process the advance tracking target, which is an object that looks like a vessel, thereby reducing the number of erroneously detected elements.

Yet another object of the present invention is to set a threshold for the number of objects to be extracted and the maximum number of advance tracking targets, thereby preventing an apparatus for high-speed tracking of a vessel from being overloaded.

In order to accomplish the above objects, a method for high-speed tracking of a vessel, performed by an apparatus for high-speed tracking of the vessel, according to the present invention includes processing a reflected radar signal that is input; extracting objects from the reflected radar signal that is processed; selecting targets from among the extracted objects; performing advance tracking of the selected targets; and tracking the vessel using the result of advance tracking when an instruction to track the vessel is received.

Here, selecting the targets may be configured to select a number of objects corresponding to the maximum number of advance tracking targets as the targets based on a priority assigned to each of the extracted objects.

Here, the priority may be set based on at least one of the cell size and the cell signal strength of the reflected radar signal corresponding to the object.

Here, the priority may be set based on a result of machine learning performed on information about the extracted objects.

Here, selecting the targets may be configured to perform machine learning using a model that is trained on image data corresponding to an actual vessel in radar image information and to select the targets based on the result of machine learning.

Here, selecting the targets may include setting a selection weight for each of the objects based on at least one of the cell size and the cell signal strength of the reflected radar signal corresponding to the object; performing a primary sort on the objects based on the selection weight; performing a secondary sort on the objects by performing machine learning for the objects listed according to the primary sort; and selecting a number of objects corresponding to the maximum number of advance tracking targets as the targets, among the objects listed according to the secondary sort.

Here, performing advance tracking may include setting a gate based on the priority of each of the targets; generating multiple pieces of preliminary track data by predicting the track of the target; generating an advance tracking result for the target by combining the multiple pieces of preliminary track data; and storing the generated advance tracking result.

Here, generating the advance tracking result may be configured to generate the advance tracking result by setting a tracking weight for the target based on a result of machine learning performed using radar image information and by combining the multiple pieces of preliminary track data for the target for which the tracking weight is set.

Here, extracting the objects may be configured to extract the object when the amplitude of the reflected radar signal is equal to or greater than a threshold amplitude.

Also, an apparatus for high-speed tracking of a vessel according to an embodiment of the present invention includes a preprocessing unit for processing a reflected radar signal that is input thereto; an object extraction unit for extracting objects from the reflected radar signal that is processed; an advance tracking target selection unit for selecting targets from among the extracted objects; an advance tracking unit for performing advance tracking of the selected targets; and a high-speed vessel-tracking unit for tracking the vessel using the result of advance tracking when an instruction to track the vessel is received.

Here, the advance tracking target selection unit may select a number of objects corresponding to the maximum number of advance tracking targets as the targets based on a priority assigned to each of the extracted objects.

Here, the priority may be set based on at least one of the cell size and the cell signal strength of the reflected radar signal corresponding to the object.

Here, the priority may be set based on a result of machine learning performed on information about the extracted objects.

Here, the advance tracking target selection unit may perform machine learning using a model trained on image data corresponding to an actual vessel in radar image information and select the targets based on the result of machine learning.

Here, the advance tracking target selection unit may set a selection weight for each of the objects based on at least one of the cell size and the cell signal strength of the reflected radar signal corresponding to the object, perform a primary sort on the objects based on the selection weight, perform a secondary sort on the objects by performing machine learning for the objects listed according to the primary sort, and select a number of objects corresponding to the maximum number of advance tracking targets as the targets, among the objects listed according to the secondary sort.

Here, the advance tracking unit may set a gate based on the priority of each of the targets, generate multiple pieces of preliminary track data by predicting the track of the target, generate an advance tracking result for the target by combining the multiple pieces of preliminary track data, and store the generated advance tracking result.

Here, the advance tracking unit may generate the advance tracking result by setting a tracking weight for the target based on a result of machine learning performed using radar image information and by combining the multiple pieces of preliminary track data for the target for which the tracking weight is set.

Here, the object extraction unit may extract the object when the amplitude of the reflected radar signal is equal to or greater than a threshold amplitude.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view that schematically shows an environment in which an apparatus for high-speed tracking of a vessel according to an embodiment of the present invention is applied;

FIG. 2 is a block diagram that shows the configuration of an apparatus for high-speed tracking of a vessel according to an embodiment of the present invention;

FIG. 3 is a flowchart for explaining a method for high-speed tracking of a vessel according to an embodiment of the present invention;

FIG. 4 is a view for explaining a high-speed vessel-tracking process of a vessel traffic control system according to an embodiment of the present invention;

FIG. 5 is a flowchart for explaining the process of selecting the advance tracking target according to an embodiment of the present invention;

FIG. 6 is a flowchart for explaining an advance tracking process according to an embodiment of the present invention; and

FIG. 7 is a block diagram that shows a computer system according to an embodiment of the present invention.

### DESCRIPTION OF THE PREFERRED EMBODIMENTS

Because the present invention may be variously changed and may have various embodiments, specific embodiments will be described in detail below with reference to the attached drawings.

However, it should be understood that those embodiments are not intended to limit the present invention to specific disclosure forms and that they include all changes, equivalents or modifications included in the spirit and scope of the present invention.

The terms used in the present specification are merely used to describe specific embodiments, and are not intended to limit the present invention. A singular expression includes a plural expression unless a description to the contrary is specifically pointed out in context. In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Unless differently defined, all terms used here including technical or scientific terms have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, a preferred embodiment of the present invention will be described in detail with reference to the accompanying drawings. In the following description of the present invention, the same reference numerals are used to designate the same or similar elements throughout the drawings, and repeated descriptions of the same components will be omitted.

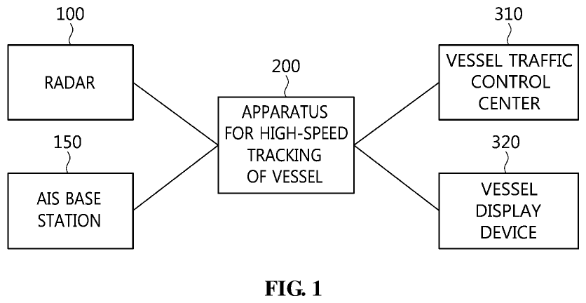

FIG. 1 is a view that schematically shows an environment in which an apparatus for high-speed tracking of a vessel according to an embodiment of the present invention is applied.

As shown in FIG. 1, the high-speed vessel-tracking apparatus 200 receives data from at least one radar device 100 and at least one AIS base station 150, thereby quickly tracking a vessel. Also, the high-speed vessel-tracking apparatus 200 may transmit the result of vessel tracking to a vessel traffic control center 310 or output the same through a vessel display device 320.

The radar device 100 may be 2D sea surveillance radar, and the antenna thereof may transmit a signal by rotating at regular intervals and receive a signal reflected from elements of the marine environment. The received signal may include signals and noise reflected from objects, such as a vessel and the like, clutter from terrain such as islands or shores, clutter from waves or the like, and clutter from snow, rain, or the like. Also, the radar device 100 collects radar images presented in the form of a distance and azimuth in a polar coordinate system. The collected radar images may be B-Scope data, and may be a Plan Position Indicator (PPI) radar image transformed into an orthogonal coordinate system.

The AIS base station 150 may receive Maritime Mobile Service Identity (MMSI) information for automatic identification of a vessel, position information, dynamic information, and the like from an Automatic Identification System (AIS) installed in the vessel and transmit the same to the high-speed vessel-tracking apparatus 200.

The high-speed vessel-tracking apparatus 200 receives a reflected radar signal from the radar device 100, processes the same, and extracts objects therefrom. Then, the high-speed vessel-tracking apparatus 200 selects an advance tracking target from among the extracted objects, performs advance tracking for the selected target, and stores the result thereof.

When it receives an instruction to track a vessel, the high-speed vessel-tracking apparatus 200 may perform high-speed tracking of the vessel using the result of advance tracking. Here, the high-speed vessel-tracking apparatus 200 may use the information received from the AIS base station 150 when it performs advance tracking or high-speed tracking.

As described above, the high-speed vessel-tracking apparatus 200 tracks a vessel corresponding to an instruction using information acquired through advance tracking, thereby reducing the time taken to track the vessel. Also, the high-speed vessel-tracking apparatus 200 tracks a vessel in an urgent situation, thereby helping the operator of the vessel and a VTS personnel make a decision.

Also, the high-speed vessel-tracking apparatus 200 selects an object that looks like a vessel as the advance tracking target and preferentially processes the selected target, thereby reducing the number of erroneously detected elements and improving the accuracy of vessel tracking.

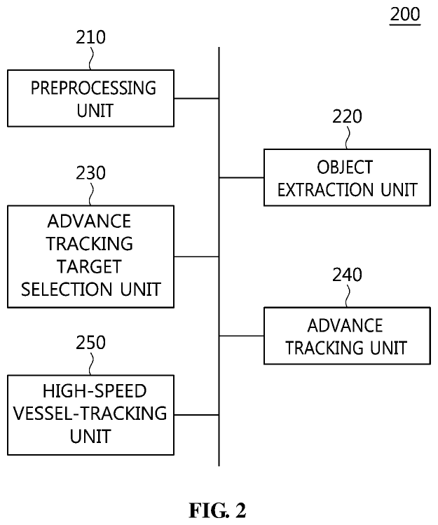

Hereinafter, the configuration of an apparatus for high-speed tracking of a vessel according to an embodiment of the present invention will be described in detail with reference to FIG. 2.

FIG. 2 is a block diagram that shows the configuration of an apparatus for high-speed tracking of a vessel according to an embodiment of the present invention.

As shown in FIG. 2, the high-speed vessel-tracking apparatus 200 includes a preprocessing unit 210, an object extraction unit 220, an advance tracking target selection unit 230, an advance tracking unit 240, and a high-speed vessel-tracking unit 250.

The preprocessing unit 210 processes a reflected radar signal that is input thereto.

The reflected radar signal includes signals and noise reflected from clutter sources, such as clutter from terrain such as islands or shores, clutter from waves or the like, and clutter from snow, rain, or the like. Accordingly, the preprocessing unit 210 eliminates the clutter and noise by processing the reflected radar signal before advance tracking of a vessel is performed. Here, the preprocessing unit 210 may eliminate sea clutter and the like by performing multiple stages of raw data signal processing.

When the reflected radar signal is processed, information about an actual vessel may be lost. Therefore, the result of signal processing performed by the preprocessing unit 210 includes large clutter that is not eliminated by a filter and information about the actual vessel, which is weakened through signal processing. Here, the clutter and the information about the actual vessel are not easily distinguished from each other, and the signal processing result may be transmitted to the vessel traffic control center 310 or the vessel display device 320 and displayed in the form of an upper layer on an electronic navigational chart.

The object extraction unit 220 extracts objects from the reflected radar signal on which signal processing is performed. Here, when the amplitude of the reflected radar signal is greater than a threshold amplitude, the object extraction unit 220 may extract an object.

When an object corresponding to a vessel is extracted using information acquired through a single radar scan, many errors may occur, and it is difficult to perform precise control. Conversely, performing multiple Kalman filtering processes for predicting positions, directions, speeds, and the like from multiple pieces of scan information is time-consuming

Conventional control systems are configured such that, when a VTS personnel inputs a tracking instruction for an image assumed to be a vessel, a target object is extracted and tracked, and information thereabout is delivered. When a vessel is determined using only a single piece of scan information in response to the request for fast tracking from a VTS personnel who monitors the risk of a collision, many errors may occur, and a prediction error, which is an error occurring when the movement of a vessel is predicted, causes damping, whereby a direction line indicative of the direction of the vessel becomes unclear. When a vessel is tracked using multiple pieces of scan information after multiple scans in order to minimize the number of errors, a lot of time is taken to track the vessel. For example, when scanning is performed every three seconds and when a vessel is tracked using four pieces of scan information, it takes 15 or more seconds to track the vessel.

In order to solve these problems, the high-speed vessel-tracking apparatus 200 according to an embodiment of the present invention extracts an object when the amplitude of the reflected radar signal is greater than a threshold amplitude, selects a target from among the extracted objects, performs advance tracking for the target, and uses the result of advance tracking. Accordingly, the high-speed vessel-tracking apparatus 200 may track a vessel using multiple pieces of scan information, thereby improving accuracy. Also, the time taken to track the vessel may be reduced by tracking the vessel using the result of advance tracking.

The advance tracking target selection unit 230 selects the advance tracking target from among the extracted objects. The advance tracking target selection unit 230 may select a number of objects corresponding to the maximum number of advance tracking targets as the advance tracking targets based on the priorities assigned to the extracted objects.

The advance tracking target selection unit 230 may set a cell size and the sum of the strengths of cell signals corresponding to each object as weights, and may sequentially assign object IDs to the objects in descending order based on the sum of the energy strengths of each cell. Here, the advance tracking target selection unit 230 sets the sum of the strengths of cell signals, corresponding to the pixels on the radar image, and the area, corresponding to a size, as the weights, and assigns the object ID based thereon.

The advance tracking target selection unit 230 may select a number of objects corresponding to the maximum number of advance tracking targets as the advance tracking targets based on the object IDs thereof. For example, when the maximum number of advance tracking targets is 20, the advance tracking target selection unit 230 may select the top 20 objects as the advance tracking targets, among the objects listed in order of object ID.

Also, the advance tracking target selection unit 230 may perform machine learning using a model that is trained on image data corresponding to an actual vessel in radar image information, and may select the advance tracking targets based on the result of machine learning.

The advance tracking target selection unit 230 may set a selection weight for an object based on at least one of the cell size and the cell signal strength of a reflected radar signal corresponding to the object. Then, the advance tracking target selection unit 230 performs a primary sort on the objects based on the selection weight, performs a secondary sort on the objects by performing machine learning for the objects listed according to the primary sort, and selects a number of objects corresponding to the maximum number of advance tracking targets as the advance tracking targets, among the objects listed according to the secondary sort.

Here, the advance tracking target selection unit 230 may select a preset number of objects from the objects listed according to the primary sort, perform machine learning for the selected objects, and select a preset number of objects as the advance tracking targets using the result of machine learning.

The advance tracking unit 240 may perform advance tracking for each of the advance tracking targets and store the result thereof. The advance tracking unit 240 may set a gate based on the priority of the target and generate preliminary track data by predicting the track of the target. Also, the advance tracking unit 240 may generate an advance tracking result for the target by combining multiple pieces of preliminary track data and store the generated advance tracking result.

Here, the advance tracking unit 240 sets a tracking weight for the target based on the result of machine learning performed using radar image information and combines the preliminary tracks for the target, for which the tracking weight is set, thereby generating the advance tracking result.

The high-speed vessel-tracking unit 250 tracks a vessel using the result of advance tracking when an instruction to track the vessel is received.

The high-speed vessel-tracking unit 250 does not cause damping because it uses the result of advance tracking when it tracks a vessel. Also, because advance tracking has been performed using multiple pieces of scan information each time scanning is performed after the high-speed vessel-tracking apparatus 200 is first operated, tracking may be stably performed compared to the conventional method, in which a vessel is tracked from the outset.

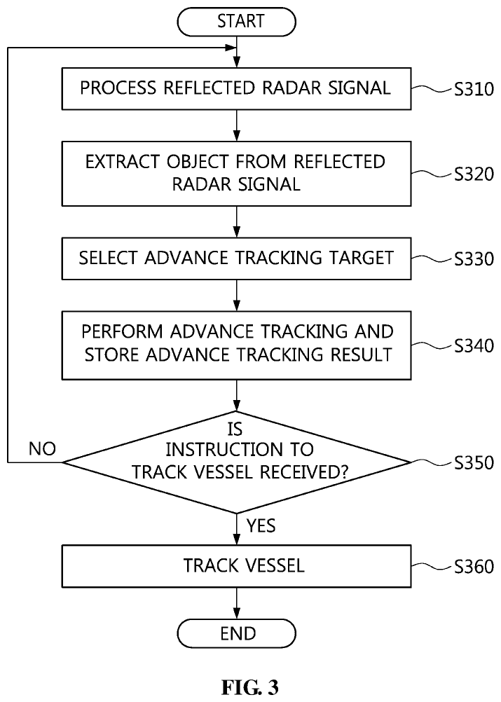

Hereinafter, a method for high-speed tracking of a vessel, performed by a high-speed vessel-tracking apparatus, according to an embodiment of the present invention will be described in more detail with reference to FIGS. 3 to 6.

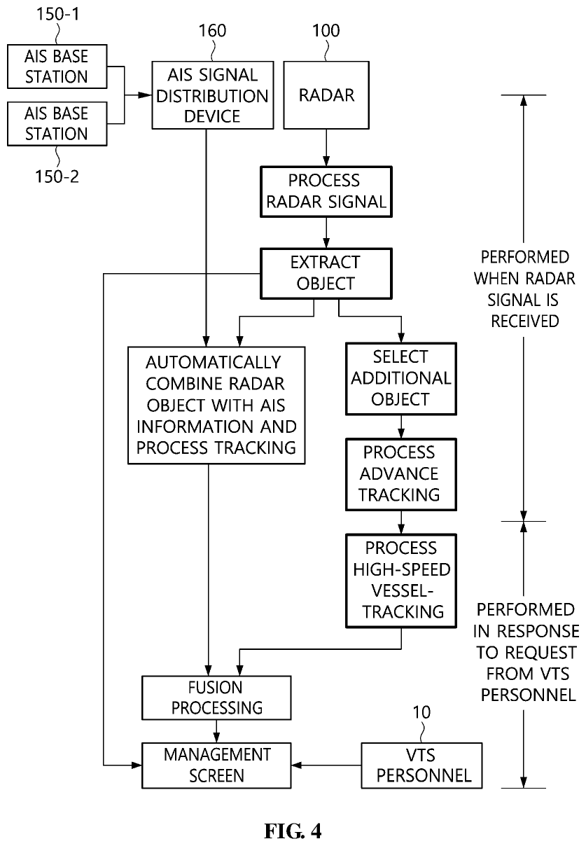

FIG. 3 is a flowchart for explaining a method for high-speed tracking of a vessel according to an embodiment of the present invention, and FIG. 4 is a view for explaining the high-speed vessel-tracking process of a vessel traffic control system according to an embodiment of the present invention.

First, the high-speed vessel-tracking apparatus 200 receives a reflected radar signal from the radar device 100 and processes the reflected radar signal at step S310.

Then, the high-speed vessel-tracking apparatus 200 extracts objects from the reflected radar signal at step S320.

The high-speed vessel-tracking apparatus 200 may extract an object when the amplitude of the reflected radar signal, on which signal processing is performed, is greater than a threshold amplitude. Here, the high-speed vessel-tracking apparatus 200 sets a threshold for the number of objects to be extracted, and may extract objects such that the number thereof is less than the threshold.

As shown in FIG. 4, the high-speed vessel-tracking apparatus 200 may compress information about the extracted objects and transmit the same to a fusion system such that a radar object is automatically combined with AIS information and tracked, and may perform a process to be described later using the information about the extracted objects.

Subsequently, the high-speed vessel-tracking apparatus 200 selects advance tracking targets at step S330.

In order to perform high-speed tracking, the high-speed vessel-tracking apparatus 200 selects advance tracking targets. The high-speed vessel-tracking apparatus 200 may set a cell size and the sum of the strengths of cell signals, corresponding to an object, as weights, and may select a number of objects corresponding to the maximum number of advance tracking targets as the advance tracking targets, among the objects extracted at step S320.

Also, the high-speed vessel-tracking apparatus 200 may extract the targets using a model that performs deep learning, in which case a number of objects corresponding to the maximum number of advance tracking targets may be selected as the targets.

Here, the maximum number of advance tracking targets may vary depending on the result of signal processing performed at step S320. Because the number of extracted objects may significantly increase or decrease depending on the value of a parameter (a CFAR parameter) in the process of extracting objects, unless the high-speed vessel-tracking apparatus 200 sets a maximum permissible number, the system thereof may be shut down due to a high computational load in the tracking process.

Accordingly, the high-speed vessel-tracking apparatus 200 according to an embodiment of the present invention sets the maximum permissible number and sets a value less than the maximum permissible number as the maximum number of advance tracking targets, thereby limiting the number of advance tracking targets.

Also, although the maximum number of advance tracking targets is set, when a CFAR level is set low, a single scan may not be completed because merely scanning a portion may cause the number of extracted objects to become greater than the maximum permissible number depending on azimuth. Accordingly, the high-speed vessel-tracking apparatus 200 may set the threshold for the number of objects to be extracted and the maximum number of advance tracking targets depending on the set parameter.

As described above, the high-speed vessel-tracking apparatus 200 according to an embodiment of the present invention selects objects that are assumed to be vessels as the advance tracking targets, performs advance tracking for the selected targets, and tracks a vessel based on the result of advance tracking, thereby reducing the time taken to track the vessel and improving the accuracy of vessel tracking.

Subsequently, the high-speed vessel-tracking apparatus 200 performs advance tracking for the target and stores the result thereof at step S340.

The high-speed vessel-tracking apparatus 200 may set a gate based on the priority of the target, generate preliminary track data by predicting the track of the target, and generate an advance tracking result for the target by combining multiple pieces of preliminary track data. In other words, the high-speed vessel-tracking apparatus 200 performs advance tracking before a VTS personnel inputs an instruction to track a vessel, thereby performing part of the vessel-tracking process in advance.

When it receives an instruction to track a vessel (YES at step S350), the high-speed vessel-tracking apparatus 200 tracks the vessel at step S360.

When it receives an instruction to track a vessel from a VTS personnel the high-speed vessel-tracking apparatus 200 may quickly track the vessel using the advance tracking result.

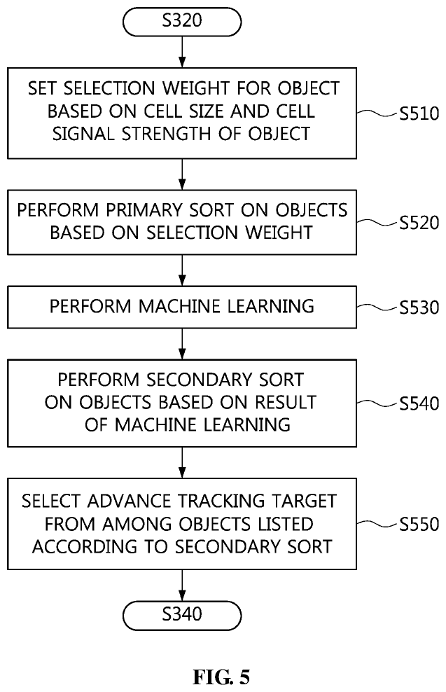

FIG. 5 is a flowchart for explaining the process of selecting an advance tracking target according to an embodiment of the present invention.

First, the high-speed vessel-tracking apparatus 200 sets a selection weight for each object based on a cell size and a cell signal strength corresponding to the object at step S510.

After it extracts objects from the reflected radar signal at step S320 in FIG. 3, the high-speed vessel-tracking apparatus 200 sets the selection weight for each of the objects based on the cell size and the cell signal strength thereof.

Then, the high-speed vessel-tracking apparatus 200 performs a primary sort on the objects based on the selection weights at step S520.

After it performs the primary sort on the objects based on the selection weights, the high-speed vessel-tracking apparatus 200 selects a preset number of objects from the sorted object list, and may perform the process of step S530 only for the selected objects.

The high-speed vessel-tracking apparatus 200 performs machine learning at step S530 and performs a secondary sort on the objects based on the result of machine learning at step S540.

The high-speed vessel-tracking apparatus 200 may perform machine learning for the selected objects and perform the secondary sort based on the result of machine learning.

Finally, the high-speed vessel-tracking apparatus 200 selects the advance tracking targets from among the objects listed according to the secondary sort at step S550.

Among the objects listed according to the secondary sort, the high-speed vessel-tracking apparatus 200 may select a number of objects corresponding to the maximum number of advance tracking targets as the advance tracking targets. Then, the high-speed vessel-tracking apparatus 200 may perform advance tracking for the selected targets by performing step S340 in FIG. 3.

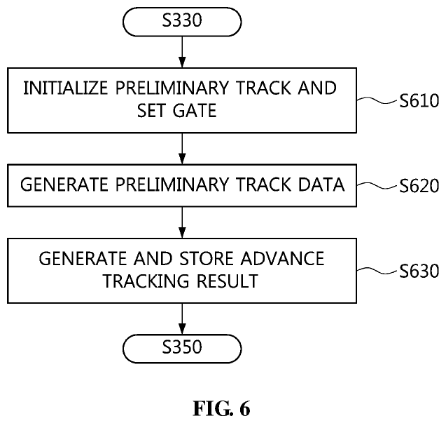

FIG. 6 is a flowchart for explaining the process of advance tracking according to an embodiment of the present invention.

The high-speed vessel-tracking apparatus 200 initializes preliminary tracks and sets a gate, which is a tracking range, at step S610.

After it selects the advance tracking targets at step S330 in FIG. 3, the high-speed vessel-tracking apparatus 200 may perform advance tracking for each of the targets as shown in FIG. 6. The high-speed vessel-tracking apparatus 200 initializes the preliminary tracks, generates preliminary track information, and sets a gate. Here, the high-speed vessel-tracking apparatus 200 may initialize the preliminary tracks and set the gate based on the object ID assigned to the target.

Then, the high-speed vessel-tracking apparatus 200 generates preliminary track data at step S620.

The high-speed vessel-tracking apparatus 200 may generate preliminary track data by predicting the track of the target.

Then, the high-speed vessel-tracking apparatus 200 generates an advance tracking result and stores the generated advance tracking result at step S630.

The high-speed vessel-tracking apparatus 200 may generate the advance tracking result for the target by combining the pieces of preliminary track data and store the generated advance tracking result. Here, the high-speed vessel-tracking apparatus 200 may update the position, the speed, the state information, and the like of the track in the preliminary track list, and may predict the position of the track, which is to be acquired through the next scan.

The advance tracking result generated and stored at step S630 is used when high-speed tracking is performed in response to an instruction to track a vessel, which is received at step S350 in FIG. 3. Also, the high-speed vessel-tracking apparatus 200 may calculate the correlation between the tracks and extract a parameter based on the correlation.

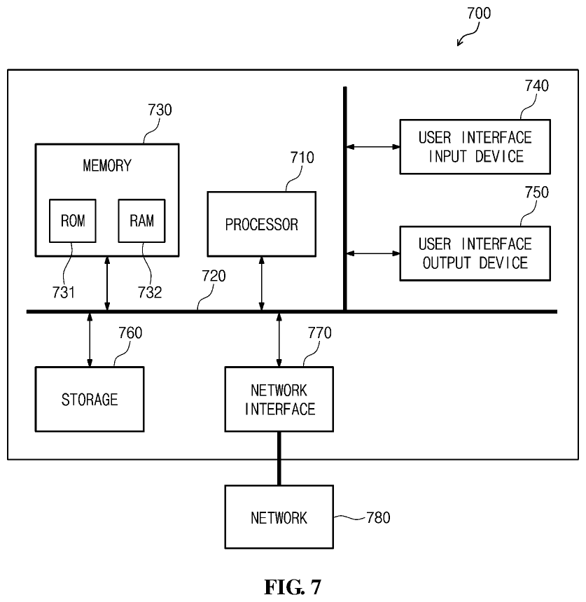

FIG. 7 is a block diagram that shows a computer system according to an embodiment of the present invention.

Referring to FIG. 7, an embodiment of the present invention may be implemented in a computer system 700 including a computer-readable recording medium. As shown in FIG. 7, the computer system 700 may include one or more processors 710, memory 730, a user-interface input device 740, a user-interface output device 750, and storage 760, which communicate with each other via a bus 720. Also, the computer system 700 may further include a network interface 770 connected to a network 780. The processor 710 may be a central processing unit or a semiconductor device for executing processing instructions stored in the memory 730 or the storage 760. The memory 730 and the storage 760 may be various types of volatile or nonvolatile storage media. For example, the memory may include ROM 731 or RAM 732.

Accordingly, an embodiment of the present invention may be implemented as a nonvolatile computer-readable storage medium in which methods implemented using a computer or instructions executable in a computer are recorded. When the computer-readable instructions are executed by a processor, the computer-readable instructions may perform a method according to at least one aspect of the present invention.

According to the present invention, advance tracking is performed by selecting an object that looks like a vessel as the target thereof, and a vessel may be quickly tracked using the result of advance tracking.

Also, according to the present invention, the risk of a collision between vessels may be quickly recognized, whereby it is possible to quickly respond thereto.

Also, according to the present invention, the advance tracking target, which is an object that looks like a vessel, is preferentially processed, whereby the number of erroneously detected elements may be reduced.

Also, according to the present invention, a threshold for the number of objects to be extracted and the maximum number of advance tracking targets may be set, whereby an apparatus for high-speed tracking of a vessel may be prevented from being overloaded.

As described above, the apparatus and method for high-speed tracking of a vessel according to the present invention are not limitedly applied to the configurations and operations of the above-described embodiments, but all or some of the embodiments may be selectively combined and configured, so that the embodiments may be modified in various ways.

What is claimed is:

1. A method for tracking of a vessel, performed by an apparatus for tracking of the vessel, comprising:
processing a reflected radar signal that is input;
extracting objects from the reflected radar signal that is processed;
selecting targets from among the extracted objects;
performing advance tracking of the selected targets; and
tracking the vessel using a result of advance tracking when an instruction to track the vessel is received.

2. The method of claim 1, wherein selecting the targets is configured to select a number of objects corresponding to a maximum number of advance tracking targets as the targets based on a priority assigned to each of the extracted objects.

3. The method of claim 2, wherein the priority is set based on at least one of a cell size and a cell signal strength of the reflected radar signal corresponding to the object.

4. The method of claim 2, wherein the priority is set based on a result of machine learning performed on information about the extracted objects.

5. The method of claim 4, wherein selecting the targets is configured to perform machine learning using a model that is trained on image data corresponding to an actual vessel in radar image information and to select the targets based on a result of machine learning.

6. The method of claim 2, wherein selecting the targets comprises:
setting a selection weight for each of the objects based on at least one of a cell size and a cell signal strength of the reflected radar signal corresponding to the object;
performing a primary sort on the objects based on the selection weight;
performing a secondary sort on the objects by performing machine learning for the objects listed according to the primary sort; and
selecting a number of objects corresponding to the maximum number of advance tracking targets as the targets, among the objects listed according to the secondary sort.

7. The method of claim 2, wherein performing advance tracking comprises:
setting a gate based on the priority of each of the targets;
generating multiple pieces of preliminary track data by predicting a track of the target;
generating an advance tracking result for the target by combining the multiple pieces of preliminary track data; and
storing the generated advance tracking result.

8. The method of claim 7, wherein generating the advance tracking result is configured to generate the advance tracking result by setting a tracking weight for the target based on a result of machine learning performed using radar image information and by combining the multiple pieces of preliminary track data for the target for which the tracking weight is set.

9. The method of claim 1, wherein extracting the objects is configured to extract the object when an amplitude of the reflected radar signal is equal to or greater than a threshold amplitude.

10. An apparatus for tracking of a vessel, comprising:
a preprocessing unit for processing a reflected radar signal that is input thereto;
an object extraction unit for extracting objects from the reflected radar signal that is processed;
an advance tracking target selection unit for selecting targets from among the extracted objects;
an advance tracking unit for performing advance tracking of the selected targets; and
a vessel-tracking unit for tracking the vessel using a result of advance tracking when an instruction to track the vessel is received.

11. The apparatus of claim 10, wherein the advance tracking target selection unit selects a number of objects corresponding to a maximum number of advance tracking targets as the targets based on a priority assigned to each of the extracted objects.

12. The apparatus of claim 11, wherein the priority is set based on at least one of a cell size and a cell signal strength of the reflected radar signal corresponding to the object.

13. The apparatus of claim 11, wherein the priority is set based on a result of machine learning performed on information about the extracted objects.

14. The apparatus of claim 13, wherein the advance tracking target selection unit performs machine learning using a model trained on image data corresponding to an actual vessel in radar image information and selects the targets based on a result of machine learning.

15. The apparatus of claim 11, wherein the advance tracking target selection unit sets a selection weight for each of the objects based on at least one of a cell size and a cell signal strength of the reflected radar signal corresponding to the object, performs a primary sort on the objects based on the selection weight, performs a secondary sort on the objects by performing machine learning for the objects listed according to the primary sort, and selects a number of objects corresponding to the maximum number of advance tracking targets as the targets, among the objects listed according to the secondary sort.

16. The apparatus of claim 11, wherein the advance tracking unit sets a gate based on the priority of each of the targets, generates multiple pieces of preliminary track data by predicting a track of the target, generates an advance tracking result for the target by combining the multiple pieces of preliminary track data, and stores the generated advance tracking result.

17. The apparatus of claim 16, wherein the advance tracking unit generates the advance tracking result by setting a tracking weight for the target based on a result of machine learning performed using radar image information and by combining the multiple pieces of preliminary track data for the target for which the tracking weight is set.

18. The apparatus of claim 10, wherein the object extraction unit extracts the object when an amplitude of the reflected radar signal is equal to or greater than a threshold amplitude.
